(19) United States
(12) Patent Application Publication
(10) Pub. No.: US 2009/0238918 A1
(43) Pub. Date: Sep. 24, 2009

(54) Corn Wet Milling Process

(76) Inventors: Robert Jansen, Portela (PT); John Kerr, South Croydon (GB); Peter Lloyd-Jones, Southport (GB); Richard Tanner, Roydon (GB)

Correspondence Address: WILLIAMS, MORGAN & AMERSON, P.C., 10333 RICHMOND, SUITE 1100, HOUSTON, TX, 77042, US

(21) Appl. No.: 12/357,555

(22) Filed: Jan. 22, 2009

Related U.S. Application Data
(60) Provisional application No. 61/023,211, filed on Jan. 24, 2008.

(51) Int. Cl. C12C 11/07; C12C 1/16

(52) U.S. Cl. 426/13; 426/28

(57) ABSTRACT

A corn wet-milling process comprises steeping corn kernels in an aqueous liquid, which produces softened corn; milling the softened corn in a first mill, which produces a first milled corn; separating germ from the first milled corn, thereby producing a germ-depleted first milled corn; milling the germ-depleted first milled corn in a second mill, producing a second milled corn; separating the second milled corn into a first starch/protein portion that comprises starch and protein and a first fiber portion that comprises fiber, starch, and protein; milling the first fiber portion in a third mill, which produces a milled fiber material that comprises fiber, starch, and protein; separating at least some of the starch and protein in the milled fiber material from the fiber therein, producing a second fiber portion that comprises fiber and starch and a second starch/protein portion that comprises starch and protein; and contacting the second fiber portion with at least one enzyme to convert at least some of the starch therein to dextrose. The converted material is screened using one or more screens to separate the fiber from the liquor. The liquor can be fermented to ethanol, or refined to dextrose. The fiber can be pressed and dried as an animal feed.

This application claims priority from U.S. provisional patent application Ser. No. 61/023,211, filed on Jan. 24, 2008, which is incorporated herein by reference.

### BACKGROUND OF THE INVENTION

Corn kernels contain starch, protein, fiber, and other substances which can be separated to make various useful products. The conventional process for wet milling corn involves steeping the corn in water containing sulfur dioxide. The softened corn is then milled to allow the separation of the four main components: starch, protein, fiber, and germ. In the conventional process, the corn is typically milled with three different mills, each one grinding more finely than the previous one. After the first (coarsest) milling step, the germ can be removed. After the second milling step, a screen is typically used to separate the free starch from the fiber. The fiber fraction is milled in a third milling step, and then washing with screens is used to remove a residual starch fraction from the fiber. The starch fraction can then be centrifuged to separate the protein therein from the starch.

In order to separate starch and protein from the fiber after the third milling, it is common to use a series of screens, sometimes as many as seven screens, with a counter-current flow of water. The aim is to separate the unbound starch and protein from the fiber, and the greater the number of screens and the greater the volume of water used, the more complete the separation tends to be. Economic removal of protein can usually be obtained with fewer screens than can the economic removal of starch. Because some starch remains bound to the fiber, and there is a practical limit to the number of screens and the volume of water that can be used, there is always some loss of starch with the fiber product. The fiber product is usually dried and sold as animal feed. The value of this product is considerably less than the value of the starch. In many instances, the fiber product of the corn wet milling process contains 15-30 wt % starch, and this represents a loss of yield of starch that can potentially be converted to dextrose.

There is a need for alternative or improved processes that can recover starch to a greater extent or more economically.

### SUMMARY OF THE INVENTION

One embodiment of the invention is a process that comprises steeping corn kernels in an aqueous liquid, which produces softened corn; milling the softened corn in a first mill, which produces a first milled corn; and separating germ from the first milled corn, thereby producing a germ-depleted first milled corn. The process also comprises milling the germ-depleted first milled corn in a second mill, producing a second milled corn; and separating the second milled corn into a first starch/protein portion that comprises starch and protein and a first fiber portion that comprises fiber, starch, and protein. The process further includes milling the first fiber portion in a third mill, which produces a milled fiber material that comprises fiber, starch, and protein. At least some of the starch and protein in the milled fiber material is separated from the fiber therein, producing a second fiber portion that comprises fiber and starch and a second starch/protein portion that comprises starch and protein. The second fiber portion is contacted with at least one enzyme to convert at least some of the starch therein to dextrose.

In some embodiments of the invention, at least some of the dextrose produced as described above can be converted to ethanol by fermentation. In other embodiments, the dextrose can be combined with dextrose produced elsewhere in the process.

In one embodiment of the process, at least some of the starch in the second fiber portion is gelatinized by heating. It is then at least partially liquefied by alpha amylase, and then at least partially saccharified by amyloglucosidase. These steps convert at least some of the starch in the second fiber portion to saccharides such as dextrose. Thus the result of this conversion is a material comprising dextrose and fiber. The fiber in this material can be separated by washing with at least one screen, which produces a dextrose-depleted fiber material and a dextrose-rich material. It should be understood that the “starch-depleted fiber material” can still contain some starch, but will contain a much lower concentration of starch on a dry solids basis than the material before the separation.

In one embodiment, the first starch/protein portion produced after the second mill can be separated into a starch-rich material and a protein-rich material. The starch-rich material can be converted enzymatically into dextrose. The dextrose produced in this part of the process can be combined with the dextrose produced as described in previous paragraphs.

In one embodiment of the invention, the separation of the milled fiber material into a second starch/protein portion and a second fiber portion comprises washing with screens. The number of screens used for this separation is determined primarily by the desired recovery of protein and secondarily by the desired recovery of starch. For example, in some embodiments of the process, the number of screens used to separate the milled fiber material into a second starch/protein portion and a second fiber portion is no greater than three. As a result, the second fiber portion will still usually contain a significant concentration of starch, which can be converted to dextrose prior to separation from the fiber, as described above. For example, in one embodiment of the process, the second fiber portion comprises about 15-60 wt % starch on a dry solids basis.

### BRIEF DESCRIPTION OF THE DRAWINGS

FIG. 1 is a process flow diagram of one embodiment of the invention.

FIG. 2 is a process flow diagram of the process used in Example 1.

FIG. 3 compares the production of dextrose over time during starch liquefaction between two alpha-amylase enzymes.

### DESCRIPTION OF ILLUSTRATIVE EMBODIMENTS

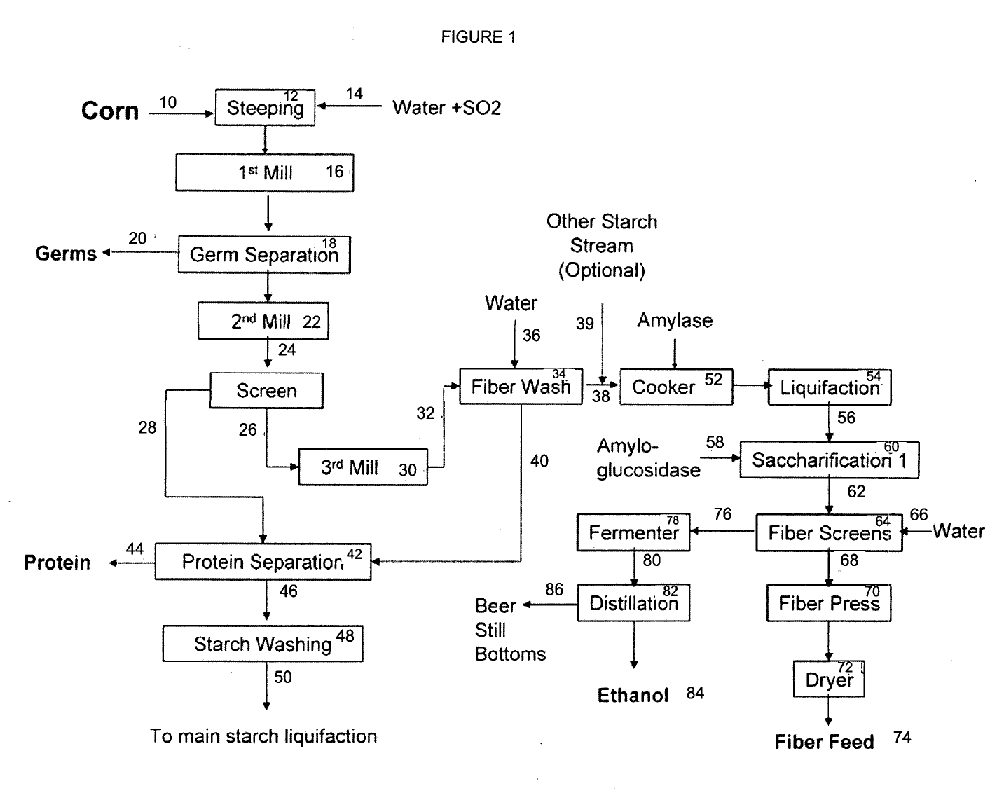

FIG. 1 shows one embodiment of the present invention. In this embodiment, corn is separated and processed into germ, protein, starch, ethanol, and fiber.

The feed 10 to the process is corn. A variety of types of corn can be used, including dent, high amylose and waxy corn. The corn is fed into a steep tank 12 which also contains water 14. Sulfur dioxide is typically added to the steep tank. The steeping system can be either batch or continuous and the residence time of the corn can be from 12 to 48 hours. The temperature during the steep is in the range 45 to 55° C. (113-131° F.). The product of the steeping step is softened corn and the liquid fraction produced is called steep liquor.

The softened corn kernels are then milled in a first mill 16 to produce a first milled corn. This relatively coarse milling allows the germ 20 to be separated 18 from the rest of the kernel. Oil can be removed from the germ and refined to make corn oil. The remainder of the germ can be dried to make corn germ meal, or it can be used as an ingredient in corn gluten feed.

After the germ is removed, the remainder of the kernel is milled 22 a second time to produce a second milled corn. This second milling, which is finer than the first, pulverizes endosperm particles in the corn kernels while leaving the fibrous material nearly intact. This second milled corn 24 is then passed through a screen to separate it into a first fiber portion 26 and a first starch/protein portion 28. The first fiber portion comprises fiber, starch, and protein, and the first starch/protein portion comprises starch and protein. The first fiber portion 26 is then milled a third time. The relatively finely milled fiber material 32 produced by the third mill 30 is then screened and washed 34 with water 36 or a recycled aqueous process stream, to separate residual starch and protein from the fiber. This separation step 34 produces a second fiber portion 38 and a second starch/protein portion 40. The second fiber portion comprises fiber and starch, and the second starch/protein material comprises protein and starch.

In contrast to the screening and washing used in a conventional corn wet milling process, the number of fiber wash screens can be reduced down to the level needed to recover the desired amount of protein from the fiber. In other words, the number of screens used can be sufficient to achieve a desirable low level of residual protein in the second fiber portion 38, even though that material 38 may still contain additional recoverable starch. Unlike the conventional process, it is not necessary to wash the second fiber portion further to obtain more complete recovery of starch, because the process provides other means for recovery of the starch downstream.

In some embodiments of the process, if the yield of protein is not considered important this screening step can be eliminated. More usually, the number of fiber wash screens can be as few as three. Similarly, the amount of wash water (or other aqueous process stream used for this purpose) can also be reduced. The second fiber portion 38 after washing can contain, in some embodiments of the process, 15-60 wt % starch on a dry solids basis (d.s.b.).

The second starch/protein portion 40 can be combined with the first starch/protein portion 28, and then subjected to a separation 42 operation, for example by centrifugation, to produce a protein-rich material 44 and a starch-rich material 46. The starch-rich material can be washed 48 to further purify it. The resulting starch 50 can be dried to produce corn starch, or can undergo further processing. For example, the starch can be hydrolyzed to produce dextrose, which can in turn be used in fermentation to produce ethanol or organic acids, or the dextrose can be converted by enzymatic treatment to high fructose corn syrup.

The second fiber portion 38, which as mentioned above still contains a significant amount of starch, is then gelatinized in a starch cooker 52. However optionally another source of starch 39 can be added at this point, and if necessary diluted with a low solids recycle process steam, or water to bring the dry solids into the range of 15 to 35%, preferably 25%. The reason for adding another starch stream will depend on the quantity of either dextrose or ethanol required from the process. Before cooking begins, the pH of the material can be adjusted to about 4.0-6.0 and alpha amylase can be added. In one embodiment, the pH of the material can be adjusted to about 4.5-5.6. In one embodiment, the pH of the material can be adjusted to about 4.0-5.0. Preferably, the alpha-amylase is active at the adjusted pH. In one embodiment, the alpha amylase is Fuelzyme™-LF (Verenium Corporation, Cambridge, Mass.). Information relating to Fuelzyme-LF is provided by Richardson, et al., J. Biol. Chem. 277:26501-26507 (2002). However, in other embodiments, other alpha-amylases, including alpha-amylases active at pH about 4.0-6.0, pH about 4.5-5.6, or pH about 4.0-5.0, may be used.

Preferably the moisture content is adjusted prior to or during the cooking step such that the dry solids content is about 15-35%, preferably about 25% by using water, preferably process waters. A number of suitable starch cookers are known in the industry, such as jet cookers. Typical temperatures for the starch cooking step are 70-110° C. (158-230° F.). The residence time in the cooker can vary, but in many cases will be about 5-10 minutes. The product from the cooker 52 can then be held in liquefaction tanks 54, for example for about 2-3 hours, to allow liquefaction of the starch by the alpha amylase to proceed.

The temperature of the liquefied material 56 is then reduced to about 60° C., the pH adjusted (if necessary) to 4.0-4.5, such as to about 4.2, and amyloglucosidase enzyme 58 is added. The liquefied material can be held for about 2 to 10 hours to allow saccharification 60 to start and the viscosity to be reduced. This partially-saccharified slurry 62 is then screened 64 to remove fiber. This can be done in a number of stages, using water 66 or a suitable recycled aqueous process stream to wash the sugars from the fiber in a counter-current manner. This water or recycled stream can be added in the final screen, with the wash water then progressing to the first screen. Suitable types of screens include DSM screens and centrifugal screens. The number of screen stages can vary from 1-7, based on the recovery requirements.

The washed fiber 68 can be pressed, for example in a screw press 70, and then dried 72, milled, and recovered 74. This fiber product can be used as animal feed.

The saccharide-rich liquid material 76 from the screens can be treated in at least two ways. If dextrose syrup is a desired product, then additional amyloglucosidase can be added to the material 76 in tanks (not shown in FIG. 1.) The total saccharification time in these tanks can typically be 24-48 hours. The fully saccharified liquor can then be added back to a dextrose stream produced from the starch 50 in the main process line, giving an enhanced yield of dextrose.

Alternatively, as shown in FIG. 1, the liquid stream can be fermented to produce ethanol. The saccharide-rich material 76 can be placed in a fermenter 78 with a microorganism that can produce ethanol. Suitable microorganisms for this purpose include Saccharomyces cerevisiae, Saccharomyces carlsbergiensis, Kluyveromyces lactis, Kluyveromyces fragilis, and any other microorganism that makes ethanol. Additional amyloglucosidase enzyme may be added, but residual amyloglucosidase enzyme from the saccharification step 60 is often sufficient to continue saccharification during fermentation. Preferably the pH is adjusted to about 4 and the temperature adjusted to about 28° C. As a result of the fermentation, most or all of the dextrose in the material 76 is converted to ethanol. The ethanol 84 can be separated from the fermentation broth 80 in a distillation unit 82. Suitable distillation temperatures can be about 60-120° C. The distillation also produces a stream that is typically referred to as beer still bottoms 86. Optionally, the ethanol can then be subjected to rectification and dehydration to produce a fuel-grade ethanol product. Another option is to produce potable ethanol by rectification.

The process of the present invention can be performed on a batch, semi-batch, or continuous basis, or some combination thereof. For example, certain steps can be performed on a batch basis while other steps are performed continuously in the same process.

Certain embodiments of the process of the present invention provide a greater yield of dextrose or ethanol than a conventional corn wet milling process. In comparison to a dry milling process which produces ethanol, certain embodiments of the present process achieve a similar yield of ethanol but provide a better yield of germ and protein, similar to that achieved in convention wet milling processes.

The fiber produced in the present process contains less starch than the fiber produced by a convention wet milling process. This may allow the fiber to be used in areas other than animal feed.

Various embodiments of the invention can be further understood from the following examples.

### Example 1

530 g of fiber from the third fiber wash screen after the third mill were collected from a corn wet mill. This fiber material had a dry solids of 25%. To this were added two liquid streams, again from the corn wet mill. The first of these were 205 g of light steep water containing mainly ash and soluble protein with a dry solids of 12%. The second was 265 g of primary centrifuge underflow which is primarily starch and has a dry solids of 40%. The primary centrifuge underflow was added to make the test representative in relation to the way a plant would be run. More starch than was present in the fiber may be required for fermentation to ethanol, and the steep water was added to bring the dry solids to about 27%.

Potassium hydroxide was added to reach pH 5.6, and 1.25 g of Liquizyme Supra was added. This is an alpha-amylase enzyme supplied by Novozymes. The sample was mixed well and then split into two equal samples of 500 g each. One of the samples was heated to 81° C. (178° F.) on a hot plate and held at this temperature for 45 minutes with agitation. At this point 50 g of the other unheated sample was added, and agitation continued for a further 30 minutes. The temperature was then increased to 98° C. (208° F.) and held for a further 45 minutes. This procedure was used to make the test similar to a continuous recycle system round the starch cooker.

The sample was then removed from the hot plate, and with continued mixing hydrochloric acid was added to bring the pH down to pH 4.3. The sample was then cooled to 63° C. (145° F.) as quickly as possible. Then 0.05 g of Spirozyme+enzyme, an amyloglucosidase enzyme supplied by Novozymes was added; the sample was agitated and maintained at 63° C. for 6 hours.

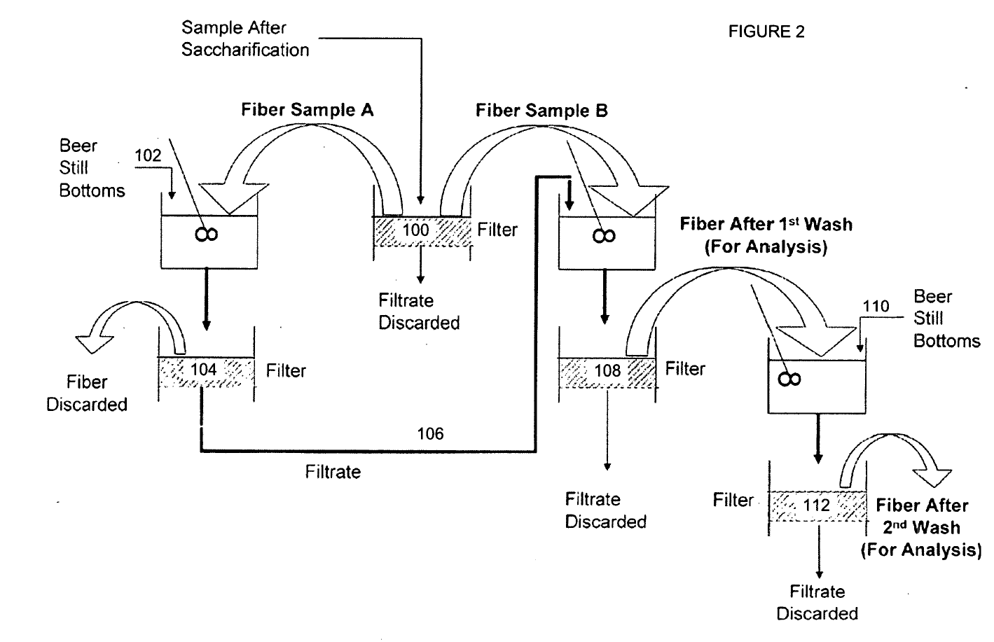

The method used for this sample is shown in FIG. 2.

The sample was first filtered on a vacuum filter 100, and was then split into two equal amounts by weight. One of these samples (sample A) was then mixed with 226 g of beer still bottoms 102, a stream from the distillery. This stream is a low solids stream containing ash and protein with a dry solids of about 8%, and is the typical stream that would be used in a factory operation The mixture of fiber and beer still bottoms was filtered 104 under vacuum, and the filtrate 106 from this first wash was collected.

Then the second half of the fiber sample (sample B) was mixed with this filtrate 106 from the first wash, and filtered 108 under vacuum. This fiber was analyzed for starch and dextrose, and the results are shown in Table 1 as “Fiber—After 1^{st} Wash”. Then this fiber was washed again by mixing with fresh beer still bottoms 110 and filtered 112. The fiber from this second wash was analyzed for starch and dextrose and the results given in Table 1 as “Fiber—After 2^{nd} Wash”.

The liquid recovered from the fiber wash can be cooled and fermented to ethanol. The washed fiber can be pressed and dried.

TABLE 1

| | Dextrose in Fiber % | Starch in Fiber % |
|---|---|---|
| Fiber-After 1^{st} Wash | 15.5 | 6.0 |
| Fiber-After 2^{nd} Wash | 9.3 | 6.7 |

The results in Table 1 show that the dextrose in the fiber can be reduced considerably by two washes. It would be expected that further washes would give a greater reduction. The starch remaining in the fiber is probably bound to the fiber, and would not be expected to reduce with further washing.

### Example 2

500 g of fiber mash were pH adjusted from 4.02 to 4.54 pH using 40% NaOH (0.58 g). 0.06 wt % of Fuelzyme™-LF (Verenium Corporation, Cambridge, Mass.) (0.09 g) were added to the mix, and the mixture was agitated and heated to 100° C. The mixture was agitated at this temperature for 90 minutes, then cooled to 62° C., at which point the pH was adjusted to 4.2 with sulfuric acid and 0.1 g glucoamylase enzyme was added. The mixture was left stirring under these conditions for about 16 hr; samples were taken for sugar analysis at 6 hr and 16 hr.

The above procedure was repeated with an alpha amylase liquefaction enzyme most active at about pH 5.6 (Novozymes, Bagsvaerd, Denmark), but in this case the initial pH adjustment was from 3.8 to 5.6 (using correspondingly more 40% NaOH (1.21 g)). Correspondingly more sulfuric acid was required to reduce the pH back down to 4.2 for the saccharification stage.

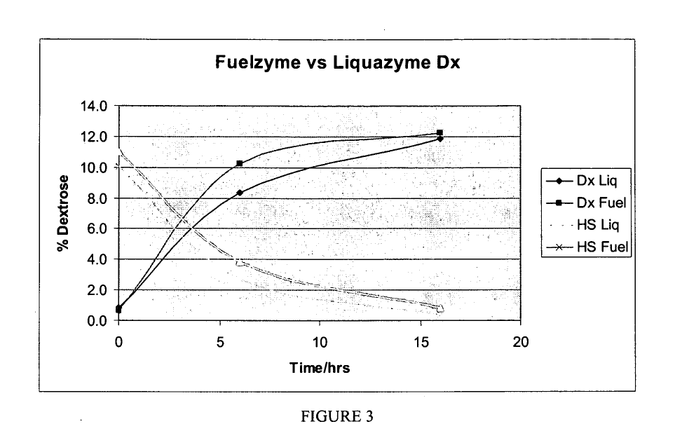

The results shown in FIG. 3 indicate that the Fuelzyme enzyme gives a good yield of dextrose very rapidly (10% Dx on sample basis after 6 hr vs about 8% Dx for the standard enzyme). After 16 hr the difference between the two enzymes is smaller but still significant. Corresponding changes in the concentrations of Higher Sugars (HS) are also seen.

### Example 3

Experiments similar to those described under Example 1 were completed on a light steep water (LSW) produced by a cereal refining process with similar observations.

### Example 4

We have found two alpha-amylases active at pH about 4.0-6.0, pH about 4.5-5.6, or pH about 4.0-5.0, other than Fuelzyme™-LF, to have comparable liquefaction activity to Fuelzyme™-LF.

The preceding description is not intended to be an exhaustive list of every possible embodiment of the present invention. Persons skilled in the art will recognize that modifications could be made to the embodiments described above which would remain within the scope of the following claims.

What is claimed is:

1. A process comprising:
steeping corn kernels in an aqueous liquid, producing softened corn;
milling the softened corn in a first mill, producing a first milled corn;
separating germ from the first milled corn, producing a germ-depleted first milled corn;
milling the germ-depleted first milled corn in a second mill, producing a second milled corn;
separating the second milled corn into a first starch/protein portion that comprises starch and protein and a first fiber portion that comprises fiber, starch, and protein;
milling the first fiber portion in a third mill, producing a milled fiber material that comprises fiber, starch, and protein;
separating at least some of the starch and protein from the fiber in the milled fiber material, producing a second fiber portion that comprises fiber and starch and a second starch/protein portion that comprises starch and protein; and
contacting the second fiber portion with at least one enzyme to convert at least some of the starch therein to dextrose.

2. The process of claim 1, further comprising converting at least some of the dextrose to ethanol by fermentation.

3. The process of claim 1, wherein at least some of the starch in the second fiber portion is gelatinized by heating, is at least partially liquefied by alpha amylase, and is at least partially saccharified by amyloglucosidase, producing a material comprising dextrose and fiber.

4. The process of claim 3, further comprising separating fiber from dextrose by washing the material that comprises dextrose and fiber with at least one screen, producing a dextrose-depleted fiber material and a dextrose-rich material.

5. The process of claim 1, further comprising separating the first starch/protein portion into a starch-rich material and a protein-rich material.

6. The process of claim 5, further comprising enzymatically converting at least some of the starch-rich material into dextrose.

7. The process of claim 1, wherein the separation of the milled fiber material into a second starch/protein portion and a second fiber portion comprises washing with screens.

8. The process of claim 7, wherein the number of screens used to separate the milled fiber material into a second starch/protein portion and a second fiber portion is determined primarily by the desired recovery of protein and secondarily by the desired recovery of starch.

9. The process of claim 8, wherein the second fiber portion comprises about 15-60 wt % starch on a dry solids basis.

10. The process of claim 1, further comprising adding a starch-containing stream to the second fiber portion prior to contacting the second fiber portion with at least one enzyme to convert at least some of the starch therein to dextrose.

11. A process comprising:
steeping corn kernels in an aqueous liquid, producing softened corn;
milling the softened corn in a first mill, producing a first milled corn;
separating germ from the first milled corn, producing a germ-depleted first milled corn;
milling the germ-depleted first milled corn in a second mill, producing a second milled corn;
separating the second milled corn into a first starch/protein portion that comprises starch and protein and a first fiber portion that comprises fiber, starch, and protein;
milling the first fiber portion in a third mill, producing a milled fiber material that comprises fiber, starch, and protein; and
contacting the milled fiber material with at least one enzyme to convert at least some of the starch therein to dextrose.

12. The process of claim 11, further comprising converting at least some of the dextrose to ethanol by fermentation.

13. The process of claim 11, wherein at least some of the starch in the milled fiber material is gelatinized by heating, is at least partially liquefied by alpha amylase, and is at least partially saccharified by amyloglucosidase, producing a material comprising dextrose and fiber.

14. The process of claim 13, wherein the alpha amylase is Fuelzyme™-LF.

15. The process of claim 13, further comprising separating fiber from dextrose by washing the material that comprises dextrose and fiber with at least one screen, producing a dextrose-depleted fiber material and a dextrose-rich material.

16. The process of claim 11, further comprising separating the first starch/protein portion into a starch-rich material and a protein-rich material.

17. The process of claim 16, further comprising enzymatically converting at least some of the starch-rich material into dextrose.

18. The process of claim 11, further comprising adding a starch-containing stream to the milled fiber material prior to contacting the milled fiber material with at least one enzyme to convert at least some of the starch therein to dextrose
